(19) United States
(12) Patent Application Publication
(10) Pub. No.: US 2026/0268411 A1
(43) Pub. Date: Sep. 10, 2026

(54) Enhanced Liquid Time-Constant Neural Network Model for Financial Portfolio Optimization

(71) Applicant: Jonathan T. Hardy, Peachtree Corners, GA (US)

(72) Inventor: Jonathan T. Hardy, Peachtree Corners, GA (US)

(21) Appl. No.: 19/032,293

(22) Filed: Jan. 20, 2025

(51) Int. Cl. G06Q 40/06; G06N 3/044; G06Q 10/04

(52) U.S. Cl. CPC G06Q 40/0631; G06N 3/044; G06Q 10/04

(57) ABSTRACT

An enhanced liquid time-constant network model for financial portfolio optimization is disclosed. The system processes historical and real-time financial data, including asset prices, volatility metrics, and correlation data, using a continuous-time neural network architecture having dynamically adjustable time constants. Internal network states evolve according to differential equations responsive to market inputs. Based on the evolved states, the system generates portfolio allocation outputs that satisfy predefined financial constraints and risk parameters. The model enables adaptive portfolio rebalancing in response to changing market conditions without requiring retraining from an initial state. By integrating principles of portfolio theory with continuous-time neural computation, the disclosed system provides a technical mechanism for dynamically optimizing asset allocations in an automated financial decision-support environment.

### CROSS-REFERENCE TO RELATED APPLICATIONS

This application is a continuation of U.S. patent application Ser. No. 19/032,293, filed Jan. 20, 2025, which is currently pending. The entirety of the prior application is incorporated herein by reference.

### STATEMENT REGARDING FEDERALLY SPONSORED RESEARCH OR DEVELOPMENT

Not applicable.

### BACKGROUND OF THE INVENTION

The present invention relates generally to financial portfolio optimization and, more particularly, to systems and methods utilizing continuous-time neural network architectures for dynamic asset allocation.

Modern Portfolio Theory (MPT) provides a mathematical framework for assembling portfolios to maximize expected return for a given level of risk. The Efficient Frontier represents optimal portfolio combinations. Traditional optimization techniques rely on static assumptions and may not adequately capture dynamic market behavior.

Stochastic processes, including Brownian motion, are widely used to model asset price evolution. Neural network models have also been employed to improve financial prediction accuracy. However, conventional discrete-time neural networks may fail to adapt efficiently to continuously evolving financial data.

### SUMMARY OF THE INVENTION

The Enhanced Liquid Time-Constant Network Model integrates continuous-time neural network architectures with portfolio optimization principles to dynamically adjust asset allocations in response to real-time financial inputs.

The system processes financial market data and evolves internal states using time-dependent parameters governed by differential equations. Portfolio allocation outputs are generated subject to financial constraints to achieve optimized risk-return profiles.

### BRIEF DESCRIPTION OF THE DRAWINGS

FIG. 1 illustrates the neural network architecture.

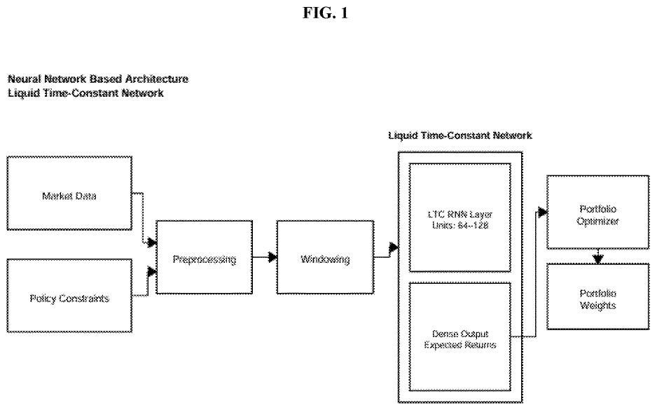

FIG. 2 illustrates feature importance ranking.

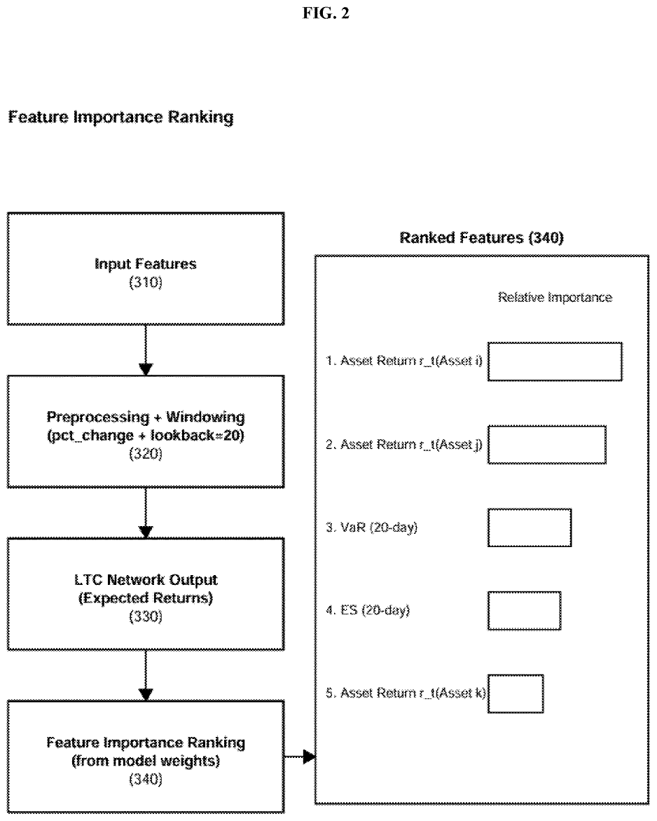

FIG. 3 illustrates portfolio allocation strategies.

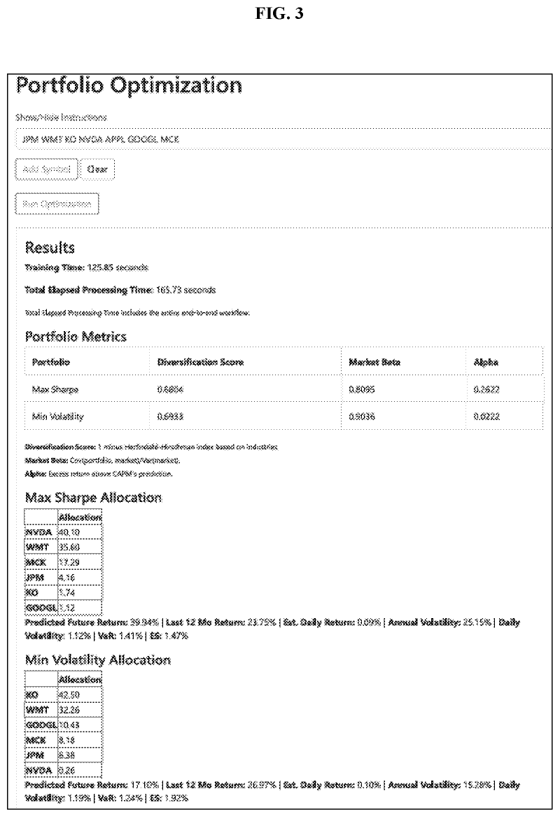

FIG. 4 illustrates an efficient frontier representation.

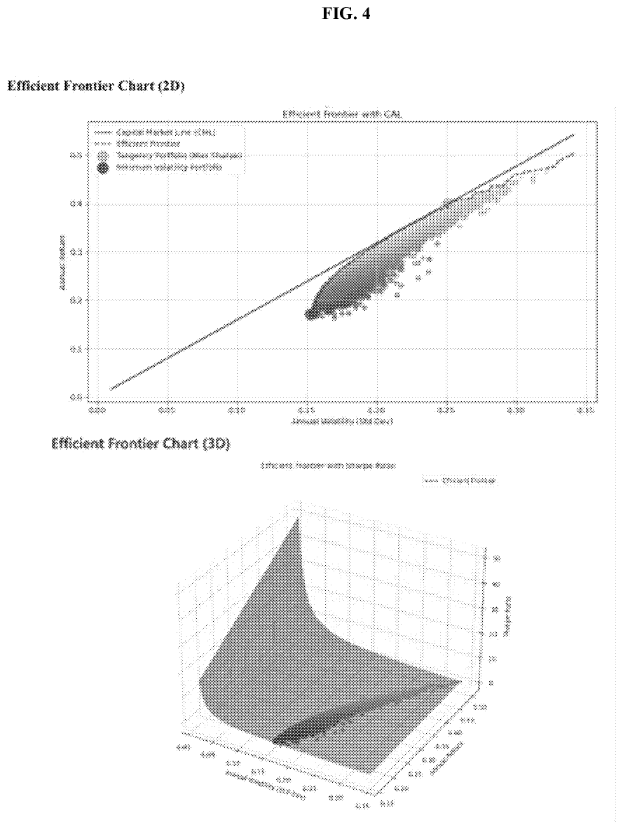

FIG. 5 illustrates a Recommendation List that provides a recommendation allocation

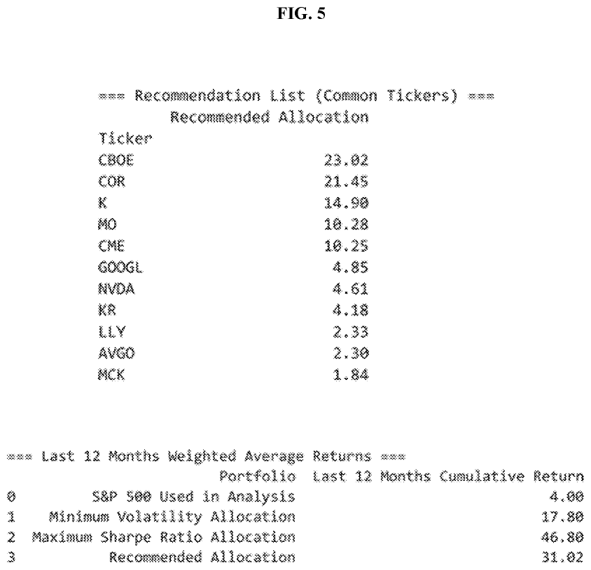

### DETAILED DESCRIPTION OF THE INVENTION

The Enhanced Liquid Time-Constant Network Model dynamically manages and optimizes investment portfolios by processing financial data in continuous time.

The system receives historical and real-time market inputs, including asset prices, volatility data, and correlation data. These inputs are processed through a continuous-time neural network having dynamically adjustable time constants.

Internal state variables evolve according to differential equations responsive to financial data inputs. Portfolio allocation outputs are generated from evolved states and are constrained by predefined financial criteria.

The system updates allocations in response to new financial data without requiring full retaining from an initial state.

### STATEMENT UNDER 37 CFR § 1.121(b)

No new matter has been introduced.

1. A computer-implemented system for financial portfolio optimization, comprising: one or more processors; a memory storing executable instructions that, when executed by the one or more processors, cause the system to: (a) receive financial input data comprising at least historical asset price data, volatility data, and correlation data for a plurality of financial instruments; (b) process the financial input data using a time-continuous neural network model having dynamically adjustable time constants, wherein the neural network model is configured to evolve internal state variables according to continuous-time differential equations; (c) generate, based on the evolved internal state variables, portfolio allocation outputs representing optimized asset weightings subject to one or more financial constraints; and (d) output the portfolio allocation outputs for execution, recommendation, or further analysis, wherein the system is configured to adapt the portfolio allocation outputs in response to changes in the financial input data over time without retraining the neural network model from an initial state.

2. A computer-implemented method for optimizing a financial portfolio, the method comprising: (a) receiving, by one or more processors, financial market data associated with a plurality of assets, the financial market data including time-series data and risk-related parameters; (b) inputting the financial market data into a time-continuous neural network model configured with variable time constants governing state evolution; (c) evolving internal states of the neural network model over continuous time in accordance with differential equations responsive to the financial market data; (d) computing portfolio allocation values based on the evolved internal states, the portfolio allocation values satisfying one or more predefined financial constraints; and (e) updating the portfolio allocation values in real time or near real time as new financial market data is received, wherein the method employs the time-continuous neural network model as a control mechanism for dynamic portfolio rebalancing.

3. A non-transitory computer-readable medium storing instructions that, when executed by one or more processors, cause the one or more processors to perform operations comprising: (a) receiving financial data associated with multiple financial instruments; (b) processing the financial data using a continuous-time neural network model with state-dependent time constants; (c) generating portfolio optimization outputs based on continuous evolution of internal network states; and (d) producing adaptive portfolio allocation recommendations in response to changes in the financial data, wherein the continuous-time neural network model is utilized as part of a financial decision-support system.
